(19) United States
(12) Patent Application Publication
(10) Pub. No.: US 2011/0228535 A1
(43) Pub. Date: Sep. 22, 2011

(54) METHOD AND STRUCTURES OF A MINIATURIZED LINE LAMP

(76) Inventor: Yi-Shiang Shao, Lujhou City (TW)

(21) Appl. No.: 12/832,706

(22) Filed: Jul. 8, 2010

(30) Foreign Application Priority Data
Mar. 19, 2010 (CN) 201020135526.8

(51) Int. Cl. F21S 4/00

(52) U.S. Cl. 362/249.02

(57) ABSTRACT

The present invention discloses a method and structures of a miniaturized line lamp. Metal wires are crossed over at two sides of an LED and are in a state of clipping, allowing the LED to be located at a same plane of the metal wires of an electric wire. Electrode positions at shorter edges of two sides of the LED are perpendicular to the metal wires and each across corner is formed respectively with a notch area which is free of electrode. A no-notch position of electrode at the other end of each side provides exactly for contact of two metal wires to form a loop. Therefore, a size of the line lamp device can better comply with a requirement of miniaturization.

### BACKGROUND OF THE INVENTION

a) Field of the Invention The present invention relates to a method and structures of a miniaturized line lamp, and more particularly to a method and structures of a miniaturized line lamp which can be effectively deployed on serially connected LEDs (Light Emitting Diodes), such that a result of serial connection can more comply with miniaturization without taking up space.

b) Description of the Prior Art

After commercialization of LED, photoelectric products have been rapidly developed and are indispensable to people's life. As continuous development, the LED can be as small as being less than 1 mm and these miniaturized products are exactly sprouting another beginning in people's life.

Currently, these miniaturized line lamps are made by serially connecting the LEDs with a thin metallic wire. However, as a conventional serial connection method is taken, meaning that the thin metallic wire is serially connected by welding underneath the LEDs, the LEDs will be protruded with a larger size, i.e., larger or higher than a cross section of the thin metal wire (including less than 2 mm of insulative rubber); in addition, a result of serially connecting an entire string of the line lamp is that the LEDs are protruded on a plane of the metal wire and the size is still large, thus it is unable to effectively control the issues of miniaturization and space taking. Moreover, the wire assembly which is formed by the serial connection cannot be provided with completeness and the space of collection is large and inconvenient that the requirement of miniaturization cannot be satisfied; therefore, the prior art cannot be really implemented in a large quantity in living, such as clothing, traffic or a military activity.

### SUMMARY OF THE INVENTION

The primary object of the present invention is to provide a method and structures of a miniaturized line lamp which provide for decreasing a size of a line lamp without taking up space, allowing an application to be wider.

In the present invention, two metal wires are crossed over two sides of an LED respectively to form a state of clipping, allowing the LED to be located on a same plane of the metal wires.

In the present invention, each across corner of the LED at a relative electrode is formed respectively with a notch area free of electrode, whereas the other end is a no-notch area of electrode. The LED is transversally located between two metal wires, allowing the two metal wires to be located at two sides of the LED, free of electrode, thereby forming a state of clipping. On the other hand, the two no-notch area of electrode can be in contact with the two metal wires respectively to form a loop. Therefore, the LED can be located on a same plane of the metal wires, which reduces a width of the line lamp and avoids that the entire line lamp is protruded by serially connecting the LEDs, thereby achieving a small size to better comply with a requirement of miniaturizing the line lamp and maintaining completeness of the wires.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a first schematic view of implementing connection of an LED with metal wires, according to the present invention.

FIG. 2 shows a schematic view of pulling the metal wires of the present invention.

FIG. 3 shows a second schematic view of implementing connection of the LED with the metal wires, according to the present invention.

FIG. 4 shows a structural view of the LED of the present invention.

FIG. 5 shows a third schematic view of implementing connection of the LED with the metal wires that the LED is located between the metal wires, according to the present invention.

### DETAILED DESCRIPTION OF THE PREFERRED EMBODIMENTS

Referring to FIG. 1, for a method of basically miniaturizing a line lamp and steadily holding an LED according to the present invention, a thin electric wire is deployed with at least one LED 10, whereas between a section of two exposed metal wires 21 of the thin electric wire is at least one LED 10 which includes two opposite illumination parts 11a, 11b and non-illumination parts 12a, 12b, 12c, 12d at four sides. On the other hand, positive and negative electrodes 121a, 121b of the LED 10 are positioned at the no-illumination parts 12a, 12b at shorter sides, whereas the two longer sides are the non-illumination parts 12c, 12d at no-electrode positions 17. The two metal wires 21, whereas, are attached on the no-illumination parts 12a, 12b at the positive and negative electrodes 121a, 121b to clip the LED 10 in-between, forming connection at solder joints 23 by an SMT (Surface Mounting Technology) or spot welding.

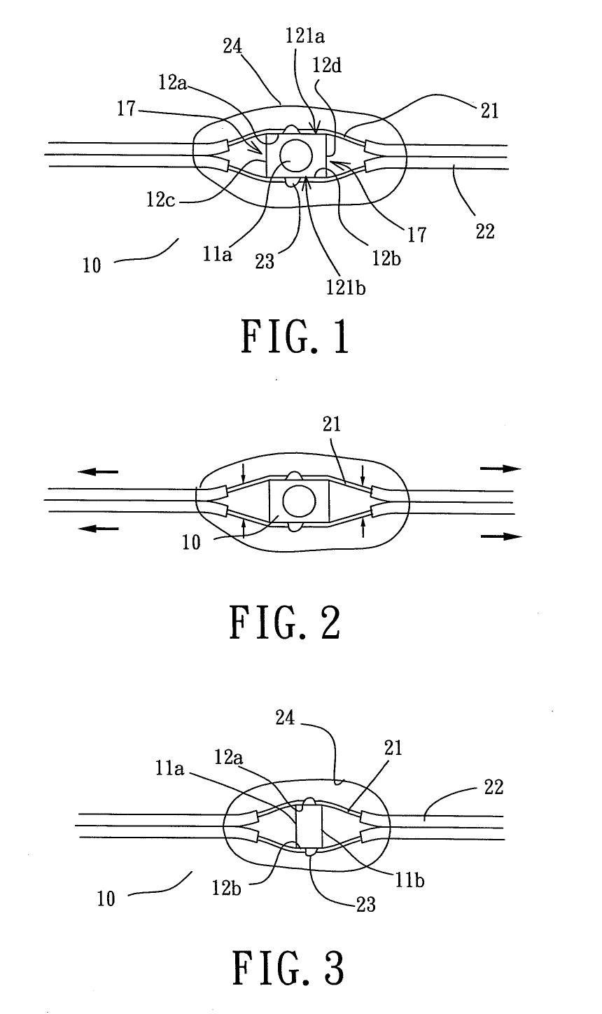

As two metal wires 21 are crossed over at two opposite positions of the LED 10 to connect in a state of clipping, the LED 10 will be on a same plane of the metal wires 21. Therefore, a sufficient clipping force will be available and once the metal wires 21 are pulled, a tighter effect will be resulted to the LED 10, as shown in FIG. 2 and it will not be easy to tear off the LED 10. Besides, as the solder joints 23 are located at two sides of the LED 10, the LED 10 will not be easy to be damaged by bending at two side ends; because, no matter which side of the LED 10 is bended, the LED 10 will be locked by containment of the other end. Even that the LED 10 is bended along a front and rear side, the damage of bending will be retarded as the metal wires 21 tightly clip the LED 10 and the LED 10 and the metal wires 21 are enclosed by protection rubber 24.

A range of the protection rubber 24 includes at least the metal wires 21 to keep from being exposed and as shown in the drawing, the preferred way is to also enclose a part of an insulation part 22.

Referring to FIG. 3, it shows another embodiment of the present invention, wherein the LED 10 in the previous drawings is turned at a different angle, allowing the illumination parts 11a, 11b at two sides to face toward the insulation part 22 to illuminate; whereas, in the present embodiment, the insulation part 22 is transparent and thus it is provided with another effect of light guiding.

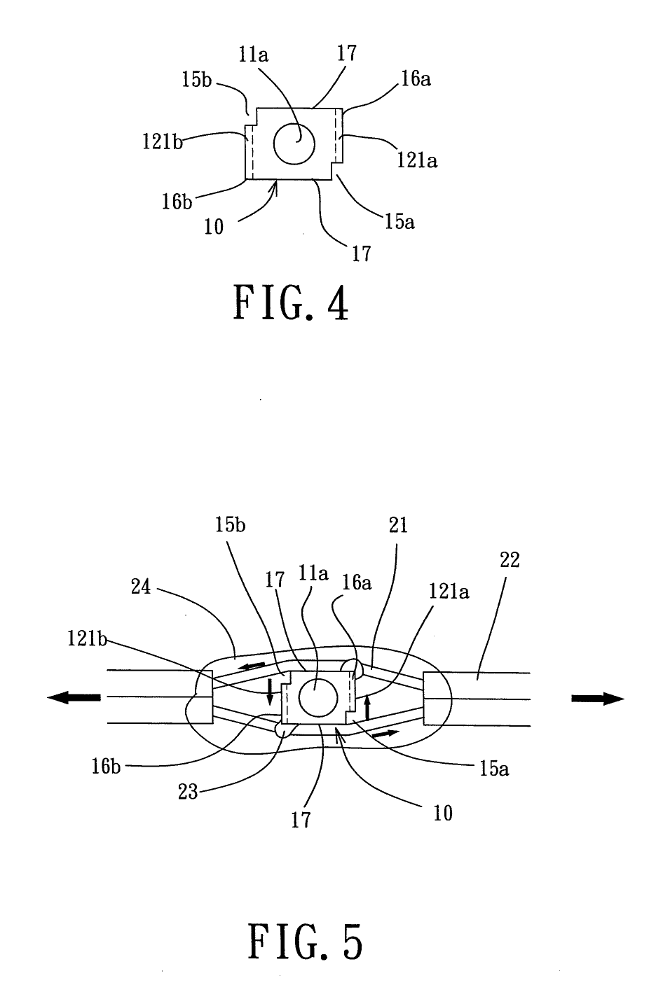

Referring to FIG. 4, it shows structures of a miniaturized line lamp of the present invention. Longer edges at upper and lower sides of the LED 10 are the no-electrode positions 17 and shorter edges at left and right sides are the positive and negative electrode positions 121a, 121b, wherein an end corner of each electrode position 121a, 121b is formed with a notch area 15a, 15b. These two notch areas 15a, 15b are at across corners and free of electrode; whereas, no-notch areas 16a, 16b at the other ends of the notch areas 15a, 15b at the electrode positions 121a, 121b are equipped with an electrode function.

Referring to FIG. 5, the no-electrode positions 17 at the longer edges can be clipped between two metal wires 21 and at this time, the no-notch electrode areas 16a, 16b at the shorter edges contact respectively the metal wires at the upper and lower sides and form connection, such as at the solder joints 23. Next, the protection rubber 24 is used to enclose the positions where the LED 10 and the two metal wires 21 are connected, thereby constituting an entire unit to isolate with ambient environment.

Accordingly, the notch areas 15a, 15b will keep at a certain distance from the metal wires 21 and the LED 10 and the metal wires 21 will be isolated by the protection rubber 24, wherein the notch areas 15a, 15b can be designed to have wider space.

In this design, the LED 10 is transversally located between the metal wires 21, reducing a longitudinal distance of the space between the metal wires 21, such that the result of positioning can allow the LED 10 to be closer to a longitudinal distance of the electric wire, thereby complying with a standard and requirement of miniaturizing the thin line lamp.

When the electric wire is pulled, as the other side of the metal wire 21 at the solder joint 23 is a free end, the two metal wires 21 will result in a downward component of force to clip more tightly the LED 10 which is again protected by the protection rubber 24, thereby assuring that the LED 10 will not be damaged by an external force.

On the other hand, when implementing the present invention, an electronic element which can execute a certain function, such as a current limiting resistor, can be provided in the LED 10 as required. Therefore, it can avoid a trouble of adding a current limiting device at the wire end on the structures of serially connected LEDs.

As the present invention can diminish space to be occupied that the size can be almost at a same width of the electric wire, effects of facilitating processing and invisibility can be developed on collection, wiring or braiding; in addition, the effects can be manifested when the present invention is applied to traffic, decoration, clothing or a military activity.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method and structures of a miniaturized line lamp, wherein a thin electric wire is deployed with at least one LED (Light Emitting Diode), between a section of two exposed metal wires of the electric wire is provided with at least one LED which is located on a same plane of the metal wires, and two metal wires are connected with positive and negative electrode positions of the LED and clip the LED in-between.

2. A method and structures of a miniaturized line lamp, comprising at least one LED, with illumination parts at longer edges of upper and lower sides being no-electrode positions, shorter edges of left and right sides being provided with positive and negative electrode positions, an end corner of each electrode position forming respectively a notch area, two notch areas being at across corners and free of electrode, and the other ends of the notch areas at two electrode positions being no-notch areas which are equipped with an electrode function; at least two metal wires which are crossed over at the no-electrode positions of the LED respectively and contact the no-notch areas at the positive and negative electrode positions, respectively; and protection rubber which encloses positions where the LED and the contacted metal wires are connected, forming an entire line lamp to isolate with ambient environment.
